(19) United States
(12) Patent Application Publication
(10) Pub. No.: US 2025/0276908 A1
(43) Pub. Date: Sep. 4, 2025

(54) APPARATUS AND METHOD FOR DIRECTED PRECIPITATION OF METAL CARBONATES

(71) Applicant: Uplift Geosystems LLC, BALTIMORE, MD (US)

(72) Inventor: Daniel Nothaft, Baltimore, MD (US)

(21) Appl. No.: 19/069,042

(22) Filed: Mar. 3, 2025

Related U.S. Application Data
(60) Provisional application No. 63/560,766, filed on Mar. 3, 2024.

(51) Int. Cl. C01F 5/24

(52) U.S. Cl. CPC C01F 5/24; C01P 2002/70

(57) ABSTRACT

A reactor configuration and set of operating conditions for converting metal hydroxides into metal carbonates, with a focus on magnesium. Seeding of the carbonation reaction with the desired product phase enables directed precipitation. High pressures favor the use of a pipe flow reactor. A reactor design incorporating pipe reactors with recycling of a portion of reaction slurry to achieve both reactor design objectives is described.

### FIELD OF THE INVENTION

The invention relates to methods for removing CO₂ from a CO₂-rich gas.

### BACKGROUND OF THE INVENTION

Magnesite (MgCO₃(s)) has been described as the optimal mineral phase for CO₂ storage through carbonation of silicate rocks (1, 2). This is because Mg silicate rocks have a high CO₂ storage capacity by mass and are highly abundant relative to other candidate feedstocks such as those more rich in calcium or ferrous iron. Further, magnesite is preferable to several metastable hydrated and/or basic Mg carbonate minerals (e.g., hydromagnesite, Mg₅(CO₃)₄(OH)₂·4H₂O), which are undesirable for large-scale carbon storage because they consume water, often have Mg:CO₂ stoichiometry less than 1, have large molar volume, and are soft and friable, which reduce their utility as construction materials or other industrial products. Carbon mineralization approaches have been described that entail first separating Mg(OH)₂(s) from the Mg silicate rock and then performing the reaction Mg(OH)₂+CO₂=MgCO₃+H₂O (1). This carbonation of Mg(OH)₂ is exergonic and exothermic at near earth surface pressures and temperatures. However, it is a kinetically inhibited reaction, and, where it occurs at low temperatures and pressures, is often stunted due to side reactions forming metastable hydrated and/or basic Mg carbonate minerals. Thus, there is a need for reaction systems that rapidly and selectively produce magnesite from magnesium hydroxide.

Conditions that favor magnesite formation include high CO₂ pressure (>10 bar), high temperature (100-250 C°), presence of water, and availability of seeding substrates that can act as nucleation sites for precipitation. Two seeding approaches have been explored in the literature. One involves the addition to the Mg(OH)₂ slurry of hydrophobic particles with high surface area such as hydrophobic activated carbon, which has been demonstrated to increase conversion of a slurry of Mg(OH)₂(s) in water to magnesite versus unseeded or hydrophilic seeds in experiments performed from 100° C. to 200° C. and a CO₂ pressure of 10 bar to 30 bar (3). The researchers attributed this to the water-repelling effect of hydrophobic activated carbon and its resultant increasing of rates of dehydration reactions of adsorbed Mg species, thereby favoring the formation of anhydrous magnesite over hydrated Mg carbonate phases. A second approach entails the mixing of pre-formed magnesite crystals into the fresh feed of Mg(OH)₂ (2). This has been demonstrated to favor conversion of Mg(OH)₂ to magnesite. To be specific, a 2.9 mass % Mg(OH)₂ slurry in water to which magnesite was added in a molar proportion of 30% magnesite to 70% Mg(OH)₂ was found to have a conversion of Mg(OH)₂ to magnesite approaching 95% at 75 minutes of reaction at 150 C°, whereas a non-seeded experiment at the same conditions produced only hydromagnesite.

### SUMMARY OF THE INVENTION

The magnesite seeding approach has the advantage over the hydrophobic particle seeding approach in that magnesite seeding does not require addition of materials exogenous to the MgO—CO₂—H₂O system. While both approaches have shown promising results, they have only been performed at laboratory scales (<1 L volume) in batch or semi-batch reactors. The innovation proposed here is a reactor and process design that allows pressurized seeded crystallization reactors to function efficiently a scale that is meaningful for CO₂ emissions mitigation, that is, >100 kt CO₂ stored/yr or more per plant (FIG. 1).

One reactor/process design choice that can increase throughput and product consistency is moving from batch to continuous mode of operation. Continuous reactor designs that could be capable of performing pressurized reactions include continuous stirred tank reactors (CSTR) or tubular reactors, also known as pipe [flow] reactors, which can take the idealized theoretical form of a plug-flow reactors (PFR). Since wall thickness for a pressure vessel is directly related to pressure and diameter, it is optimal to design a reactor with minimal diameter. A tubular reactor is better in this regard relative to a CSTR. Tubular reactors have previously been proposed for heated and pressurized carbonation reactions directly from silicate minerals (4), but such a reaction configuration has not been proposed for carbonation of Mg(OH)₂.

Here, a process and reactor configuration is proposed in which a continuous stream of Mg(OH)₂ is carbonated in a tubular reactor, and a portion of the outflow of the carbonation reactor is split (10% to 70%, preferably 30% to 50%) and recycled at the inflow where fresh Mg(OH)₂ aqueous slurry is mixed with a pressurized CO₂-rich gas stream (FIG. 1). While 15 bar PCO₂ has been identified as an effective CO₂ partial pressure to convert Mg(OH)₂ to MgCO₃ in the presence of MgCO₃ seeds, these experiments were only reported for pure CO₂ (2). It is noted here that reactions of equivalent PCO₂ could be performed in a mixed gas at higher total pressure. For example, a 20% CO₂, 80% N₂ gas mixture at a total pressure of 75 bar should theoretically carbonate Mg(OH)₂ similarly since the PCO₂ would still be 15 bar. Not having to separate pure CO₂ from a mixed stream in order to store the CO₂ is a major benefit of carbon mineralization reactions. The high total pressures that may be required to carbonate a mixed gas stream to magnesite in this way underscores the importance of minimal diameter reactor designs such as the tubular reactor system proposed here. It is noted that partial refining of a flue gas stream could be beneficial and cost-effective (i.e. upgrading a 5% CO₂ stream to a 50% CO₂ stream). If a mixed gas stream is run through a compressor and then introduced into the reactor, it is noted that the CO₂-lean outflow gas may be expanded through a turbine to recover some of the energy of compression that was input to the inflow gas mixture.

Accordingly, there is provided a method for the carbonation of Mg(OH)₂, comprising:
a. Mixing a slurry of Mg(OH)₂ in water with magnesite (MgCO₃). Preferably, the mass ratio of Mg(OH)₂ to MgCO₃ should be in the range of 60:40 to 90:10. The total suspended solids in the slurry can be up to 40 percent by weight (wt %), preferably 2 wt % to 20 wt %.
b. Pumping the Mg(OH)₂-magnesite slurry into a tubular reactor; see FIG. 1.
c. Applying heat to reactor tubing to maintain a consistent temperature of 70° C. to 250° C., preferably 120° C. to 150° C.
d. Injecting a CO₂-rich gas into the tubular reactor such that the partial pressure of CO₂ (PCO₂) is 10 bar to 30 bar, preferably 15 bar. The CO₂-rich gas may be a mixture of other gases such as N₂. The tubular reactor should be of appropriate materials of construction, diameter, and wall thickness to stably maintain the total pressure of the gas mixture. Thick-walled stainless steel is generally a suitable choice of tubing for this reactor. The pressurized CO₂ will react with the slurry or solution to precipitate magnesite through the mildly exothermic net reaction Mg(OH)₂+CO₂=MgCO₃+H₂O. A pressure head differential is maintained along the tubular reactor flow path to force the slurry to migrate continuously through the reactor in the manner of pipe flow reactor. Additional CO₂-rich gas may be injected at multiple points along the reactor flow path to maintain suitable pressure conditions to drive the reaction towards completion. Residence times of the slurry within the tubular reactor can be 10 minutes to 180 minutes, preferably 30 minutes to 90 minutes.
e. Recycling a portion (10% to 70%, preferably 30% to 50%) of the fully-reacted magnesite slurry to the start of the process where the magnesite is mixed with Mg(OH)₂. The magnesite acts as a seed to direct precipitation towards the anhydrous form of magnesium carbonate, thereby avoiding undesirable hydrous or basic magnesium carbonate forms that have faster precipitation kinetics in the absence of magnesite seed particles.
f. Decompressing the remaining magnesite slurry. If there is residual CO₂ dissolved in the slurry, this may be separated, concentrated, and recycled to the start of the process. There may be opportunities to recover energy at this stage through the expansion of compressed gases and/or heat exchange from the warm slurry.
g. Separating solids and liquids in the magnesite slurry, such as by settling or filtration.
h. Recycling whatever fluids are needed to the start of the process and discharge the remaining fluids for another beneficial reuse or as wastewater.

### BRIEF DESCRIPTION OF DRAWINGS

FIG. 1 is a process flow diagram for continuous pressurized seeded carbonation reactions according to an embodiment of the invention.

### DETAILED DESCRIPTION OF THE INVENTION

Laboratory experiments were conducted to corroborate literature reports of enhancement of magnesite precipitation kinetics upon addition of magnesite seeds to a Mg(OH)₂ slurry. Two sources of Mg(OH)₂ were used. The first was an ACS reagent grade powder sourced from a laboratory chemical vendor. The second was synthesized from a natural serpentinite in a pH swing process using HCl and NaOH. Precipitates from the leachate were collected at pH 9.42 and then 12.72. Most of the Fe, Ni, and other transition metals were concentrated in the first precipitate, whereas Mg was effectively concentrated in the second precipitate, which also contained minor Ca, Na, and Cl. The second precipitate, which was confirmed by X-Ray diffraction to be dominantly brucite, was used in carbonation experiments. Magnesite seed particles used in the experiments were hydrothermally synthesized from hydromagnesite in the presence of pressurized CO₂ using methods adapted from Swanson et al. (2).

The Mg(OH)₂ and magnesite were loaded into a stainless steel pressure vessel at a mass ratio of 62:38, to which deionized water was added to a achieve a slurry of 3 wt % solids. An internal agitator commenced stirring the mixture at a rate of 300 rotations per minute. The vessel headspace was evacuated and then sealed. A 15 bar CO₂ source was then opened to the vessel. The vessel was then heated via an external heating jacket to 150 C°. After 120 minutes at this temperature, the heating jacket was turned off and removed, and cooling water was flushed through a cooling loop inside the reactor to bring it to a safe handling temperature of <50 C°. At this point, the CO₂ source was turned off and the vessel was vented to atmospheric pressure. The vessel was then disassembled and its contents subjected to vacuum filtration using Whatman filter paper and a Buchner funnel. The solids retained on the filter were dried, weighed, and analyzed by X-Ray diffraction to determine their crystal structures.

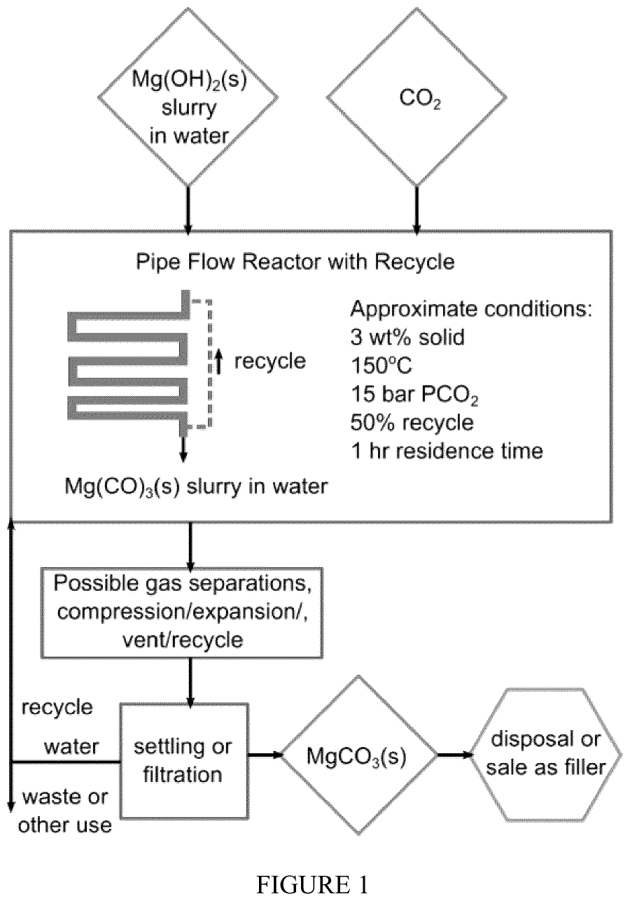

The only crystal phase detected in the solids after carbonation of the lab-grade Mg(OH)₂ was magnesite (Table 1). The carbonated solids derived from the Mg(OH)₂ synthesized from natural serpentinite were also dominated by magnesite, although faint diffraction peaks attributed to nesquehonite and halite were also observed. Yields of the conversion of Mg(OH)₂ to magnesite were estimated from the mass change of the solids before and after the experiment. The conversions determined for the lab-grade and serpentinite-derived Mg(OH)₂ were 76% and 99%, respectively. It is hard to avoid some loss of material during the transfer from the reaction vessel to the filtration apparatus, which likely accounts in part for the conversions being <100%. The reason for the higher apparent yield of the serpentinite-derived Mg(OH)₂ experiment is likely due to its containing minor nesquehonite. In a set of hydrothermal experiments of Mg(OH)₂ carbonation in the same reactor without addition of magnesite seeds, the reaction products were almost entirely hydromagnesite, with only occasional, trace diffraction peaks for magnesite and other Mg-carbonate phases. Thus, these experiments collectively demonstrate that magnesite seeding effectively encourages selective conversion to magnesite at moderate hydrothermal temperatures. Given the elevated pressures used in the reactions, the use of a pipe reactor (FIG. 1) is a wise choice to minimize reactor wall thickness and maximize throughput.

TABLE 1
Conversion of magnesium hydroxide to magnesite in experiments
with magnesite seeds added at 150 C. °, 15 bar PCO₂, and
120 minutes reaction time. Yields were estimated from mass change.

| | | MgCO₃ phases |
|---|---|---|
| | Yield of | observed in product |
| Mg(OH)₂ source | Mg(OH)₂ | (XRD) |
| vendor lab-grade stock | 76% | magnesite |
| Synthesized from natural | 99%* | magnesite, trace |
| serpentinite by pH swing. | | nesquehonite, trace halite |

*Yield estimated by mass change may be somewhat inflated due to presence of nesquehonite.

### REFERENCES CITED

1. K. S. Lackner, D. P. Butt, C. H. Wendt, Progress on Binding CO₂ in Mineral Substrates (1997).
2. E. J. Swanson, K. J. Fricker, M. Sun, A. H. A. Park, Directed precipitation of hydrated and anhydrous magnesium carbonates for carbon storage. Phys. Chem. Chem. Phys. 16, 23440-23450 (2014).
3. S. Atashin, R. A. Varin, J. Z. Wen, Directed precipitation of anhydrous magnesite for improved performance of mineral carbonation of CO₂. J. Environ. Chem. Eng. 5, 3362-3372 (2017).
4. W. K. O'Connor et al., Aqueous Mineral Carbonation: Mineral Availability, Pretreatment, Reaction Parametrics, and Process Studies. Doe/Arc-Tr-04-002, 1-19 (2005).

1. A method for carbonation of Mg(OH)₂, comprising the steps
a. Mixing a slurry of Mg(OH)₂ in water with magnesite (MgCO₃).
b. Pumping the Mg(OH)₂-magnesite slurry into a tubular reactor.
c. Applying heat to reactor tubing to maintain a consistent temperature of 70° C. to 250° C.
d. Injecting a CO₂-rich gas into the tubular reactor such that the partial pressure of CO₂ (PCO₂) is 10 bar to 30 bar to permit the pressurized CO₂ to react with the slurry or solution to precipitate magnesite through an exothermic net reaction Mg(OH) 2+CO₂=MgCO₃+H₂O, wherein residence times of the slurry within the tubular reactor is 10 minutes to 180 minutes.
e. Maintaining a pressure head differential along the tubular reactor flow path to force the slurry to migrate continuously through the reactor in the manner of pipe flow reactor.
f. Recycling a portion of the fully-reacted magnesite slurry to the start of the process where the magnesite is mixed with Mg(OH)₂ to allow the magnesite to act as a seed to direct precipitation towards the anhydrous form of magnesium carbonate, inhibiting formation of undesirable hydrous or basic magnesium carbonate forms.
g. Decompressing the remaining magnesite slurry.
h. Separating solids and liquids in the magnesite slurry, such as by settling or filtration.
i. Recycling fluids separated in step h. back to step a. and discharging remaining fluids.

2. The method according to claim 1, wherein the mass ratio of Mg(OH)₂ to MgCO₃ in step a. is in the range of 60:40 to 90:10 and wherein the total suspended solids in the slurry is up to 40 percent by weight (wt %).

3. The method according to claim 2, wherein the total suspended solids in the slurry is 2 wt % to 20 wt %.

4. The method according to claim 1, wherein heat is applied to the reactor tubing in step c. to maintain a consistent temperature of 120° C. to 150° C.

5. The method according to claim 1, wherein the partial pressure of CO₂ (PCO₂) in step d. is 15 bar.

6. The method according to claim 1, wherein the CO₂-rich gas in step d. is a mixture of gases.

7. The method according to claim 1, wherein additional CO₂-rich gas is injected at multiple points along the reactor flow path to maintain desired pressure conditions to drive the reaction towards completion.

8. The method according to claim 1, wherein residence times of the slurry within the tubular reactor in step d. is 30 minutes to 90 minutes.

9. The method according to claim 1, wherein 10% to 70% of the fully-reacted magnesite slurry is recycled to the start of the process where the magnesite is mixed with Mg(OH)₂.

10. The method according to claim 1, wherein 30% to 50% of the fully-reacted magnesite slurry is recycled to the start of the process where the magnesite is mixed with Mg(OH)₂.

11. The method according to claim 1, wherein residual CO₂ dissolved in the slurry, if present is separated, concentrated, and recycled to the start of the process.
